(19) United States
(12) Patent Application Publication
(10) Pub. No.: US 2025/0305948 A1
(43) Pub. Date: Oct. 2, 2025

(54) LIGHT GUIDING HOUSING FOR MICRO SPECTROMETER

(71) Applicant: TRINAMIX GMBH, Ludwigshafen Am Rhein (DE)

(72) Inventors: Wei-Shan WANG, Ludwigshafen am Rhein (DE); Moritz LAUBSCHER, Ludwigshafen am Rhein (DE); Sebastian VALOUCH, Ludwigshafen am Rhein (DE); Henning ZIMMERMANN, Ludwigshafen am Rhein (DE)

(21) Appl. No.: 18/865,440

(22) PCT Filed: Jun. 7, 2023
(86) PCT No.: PCT/EP23/65265

§ 371 Date: Nov. 13, 2024

(30) Foreign Application Priority Data
Jun. 8, 2022 (EP) 22177745.1

(51) Int. Cl. G01N 21/359

(52) U.S. Cl. CPC G01N 21/359; G01N 2201/0221; G01N 2201/0636

(57) ABSTRACT

Disclosed herein is a spectrometer housing configured for at least partially enclosing at least one detector and at least one emitter of a spectrometer module. The spectrometer housing includes:
a frame element;
a lid element connected to the frame element;
a separation element arranged within the frame element;
a reflector element arranged on at least a part of one or both of the lid element and the frame element; and
an interface element.

Further disclosed herein are a spectrometer module, a method of manufacturing a spectrometer housing and a method of manufacturing a spectrometer module.

### TECHNICAL FIELD

The invention relates to a spectrometer housing, a spectrometer module, a method of manufacturing at least one spectrometer housing and a method of manufacturing a spectrometer module. Generally, such devices and methods may be employed for various applications. They may specifically be used for investigation or monitoring purposes, specifically in the infrared (IR) spectral region, more specifically in the near-infrared (NIR) spectral region. However, further kinds of applications may also be possible.

### BACKGROUND ART

Complete spectrometer modules available on the markets, in which an emitter, an detector and all electronics are integrated, are typically still larger than 10 cm³. These spectrometer modules, generally, are far away from being integrated into consumer electronics such as smartphones or wearables which need a much smaller form factor, for example, less than 1 cm³. Specifically, a reflector which can maximize irradiance of the sample and fit into a spectrometer smaller than 1 cm³ is not yet available on the market. Miniaturized spectrometer modules can be categorized in mini-, micro-, and chip-size spectrometer modules based on the volume. Currently, the volume of a “chip-size” spectrometer module is typically less than 1 cm³. However, the chip-size spectrometer module is still a sub-system which may not include either an emitter or electronics in their design. To integrate the emitter and a detector into a small form factor of less than 1 cm³ is typically challenging and not yet available on the market. Below are a few examples that are available but bulky and pricy.

Miniaturized spectrometer modules are commercially available, as an example, from Spectral Engines GmbH, Steinbach, Germany, or from Insion GmbH, Obersulm, Germany. Thus, as an example, spectrometer modules are available using tungsten lamps as a light source and having a housing providing interchangeable reflection optics. Other modules use micro injection molding technologies, e.g. for manufacturing optical gratings. However, these commercially available spectrometer modules generally have a size which is still much larger than 1 cm³ or even in the range of 10 cm³ or more which generally renders and integration into smartphones or tablet computers, challenging. Further, Apple Inc., Cupertino, U.S.A. uses integrated light guiding in a smart phone, having a dot projector. A micro prism is used to guide the light. However, a micro prism is an additional pricy component and is a cost adder in the spectrometer module.

Despite the advantages implied by the above-mentioned devices and methods, there still is need for improvements. Specifically, the examples above are still too bulky for integration into a form factor that fits into consumer electronics, such as smartphones or tablet computers. Further, there still is a need for reducing costs of manufacturing and components.

### Problem to be Solved

It is therefore desirable to provide spectrometer modules and methods of manufacturing thereof which at least substantially avoid the disadvantages of known devices and methods of this type. Specifically, it is desirable to provide a miniaturized and cost-efficient spectrometer housing for at least partially enclosing a spectrometer module, specifically for integration into consumer electronics, e.g. into smartphones, wearables or tablets.

### SUMMARY

This problem is addressed by a spectrometer housing, a spectrometer module, a method of manufacturing at least one spectrometer housing and a method of manufacturing a spectrometer module, with the features of the independent claims. Advantageous embodiments which might be realized in an isolated fashion or in any arbitrary combinations are listed in the dependent claims as well as throughout the specification.

In a first aspect of the present invention, a spectrometer housing is disclosed. The term “spectrometer” as used herein is a broad term and is to be given its ordinary and customary meaning to a person of ordinary skill in the art and is not to be limited to a special or customized meaning. The term specifically may refer, without limitation, to a device or system which is configured for determining spectral information, such as information on at least one spectrum of at least one object, by recording at least one measured value for at least one signal intensity related to at least one corresponding signal wavelength of the optical radiation and by evaluating at least one measurement signal which relates to the signal intensity. The term “spectrum” including any grammatical variation thereof as used herein is a broad term and is to be given its ordinary and customary meaning to a person of ordinary skill in the art and is not to be limited to a special or customized meaning. The term specifically may refer, without limitation, to a partition of optical radiation, wherein the spectrum is constituted by an optical signal defined by a signal wavelength and a corresponding signal intensity. In particular, the spectrum may comprise spectral information related to at least one measurement object, such as a type and composition of at least one material forming the at least one measurement object, which can be determined by recording at least one spectrum related to the at least one measurement object. The term “spectrometer module” as used herein is a broad term and is to be given its ordinary and customary meaning to a person of ordinary skill in the art and is not to be limited to a special or customized meaning. The term specifically may refer, without limitation, to a spectrometer being part of a system, specifically of a modular system, e.g. a smartphone, the modular system comprising a plurality of interacting and/or autonomous functional modules. The spectrometer module may be configured for at least one of performing at least one specific task within the system and communicating with further elements of the system. Further options may be feasible.

The term “system” as used herein is a broad term and is to be given its ordinary and customary meaning to a person of ordinary skill in the art and is not to be limited to a special or customized meaning. The term specifically may refer, without limitation, to an arbitrary set of interacting or interdependent components or parts forming a whole. Specifically, the components may interact with each other in order to fulfill at least one common function. The at least two components may be handled independently or may be coupled or connectable. The term “module” including any grammatical variation thereof as used herein is a broad term and is to be given its ordinary and customary meaning to a person of ordinary skill in the art and is not to be limited to a special or customized meaning. The term specifically may refer, without limitation, to at least one element of a system, e.g. to exactly one element of the system. The element may be a subsystem comprising at least one further element. At least two modules of the system may share elements, e.g. electronics, such as a circuit board. As an example, the system may be a smartphone and/or wearable, i.e. a smartwatch, comprising a spectrometer module, a touch display module and circuit board, wherein both the spectrometer module and the touch display module may be controlled by using the circuit board. A variety of further options are feasible and generally known to the skilled person. A modular system may specifically facilitate production and maintenance of the system. A module may be replaceable in the system, e.g. by another module of the same kind. Thus, specifically, the term “module”, as the skilled person will understand, may refer to a functional unit which may form a part of a system, and which may perform at least one function, by itself, and/or in interaction with one or more other modules, and which, as an example, may be formed as a unit.

The term “housing” as used herein is a broad term and is to be given its ordinary and customary meaning to a person of ordinary skill in the art and is not to be limited to a special or customized meaning. The term specifically may refer, without limitation, to a mechanical cover configured for at least partially shielding elements in its interior. The housing may specifically be configured for at least partially shielding elements in its interior from external influences of mechanical nature, such as from collisions with further objects and/or from vibrations. The housing may comprise at least one wall, specifically at least one solid and non-deformable wall. The housing may further specifically be configured for at least partially shielding electromagnetic radiation, such as optical radiation or thermal radiation. The housing, specifically at least one wall of the housing, may comprise at least one opening, such as an opening through which optical radiation can pass. The housing, as an example, may fully or partially be made of at least one rigid material, such as of at least one plastic material and/or at least one metallic material. As will be outlined in further detail below, the housing specifically may fully or partially be made by at least one molded plastic material.

The term “spectrometer housing” as used herein is a broad term and is to be given its ordinary and customary meaning to a person of ordinary skill in the art and is not to be limited to a special or customized meaning. The term specifically may refer, without limitation, to a housing for at least one spectrometer, specifically for at least one spectrometer module. The spectrometer housing may be configured for covering the spectrometer module within a system, such as within a smartphone. The spectrometer housing may be configured for covering the spectrometer module outside of the system, e.g. under ambient conditions, e.g. when removing the spectrometer module for maintenance purposes. As will be outlined in further detail below, the spectrometer housing may specifically be configured for guiding optical radiation within the spectrometer module, specifically by using a reflector element, such as for defining radiance intensity angles, specifically for maximizing irradiance of a measurement object. As will also be outlined in further detail below, the spectrometer housing may specifically be a miniaturized spectrometer housing, e.g. a miniaturized spectrometer housing configured for integration into at least one of a smartphone and a tablet.

The spectrometer housing is configured for at least partially enclosing at least one detector and at least one emitter of a spectrometer module. Specifically, the spectrometer housing may be configured for enclosing the entire spectrometer module. The spectrometer housing may be configured for enclosing the entire detector of the spectrometer module. The spectrometer housing may be configured for enclosing the entire emitter of the spectrometer module. The spectrometer housing may be configured for enclosing only parts of the detector of the spectrometer module. The spectrometer housing may be configured for enclosing only parts of the emitter of the spectrometer module. The spectrometer housing may be configured for enclosing at least one further optional component of the spectrometer module or at least a part thereof.

The term “detector” as used herein is a broad term and is to be given its ordinary and customary meaning to a person of ordinary skill in the art and is not to be limited to a special or customized meaning. The term specifically may refer, without limitation, to an optical sensor configured for detecting or measuring optical radiation, such as for detecting an illumination and/or a light spot generated by at least one light beam. The detector may specifically comprise at least one photosensitive region. The photosensitive region may be configured for being illuminated, or in other words for receiving optical radiation, and for generating at least one signal, such as an electronic signal, in response to the illumination. The photosensitive region may be located on a surface of the photodetector. The photosensitive region may specifically be a single, closed, uniform photosensitive region. However, other options may also be feasible.

The term “illumination” as used herein is a broad term and is to be given its ordinary and customary meaning to a person of ordinary skill in the art and is not to be limited to a special or customized meaning. The term specifically may refer, without limitation, to optical radiation, specifically within at least one of the visible, the ultraviolet or the infrared spectral range. The term “ultraviolet”, generally, refers to electromagnetic radiation having a wavelength of 1 nm to 380 nm, preferably of 100 nm to 380 nm. Further, the term “visible”, generally, refers to a wavelength of 380 nm to 760 nm. Further, the term “infrared”, “abbreviated to IR”, generally refers to a wavelength of 760 nm to 1000 μm, wherein the wavelength of 760 nm to 3 μm is, usually, denominated as “near infrared”, abbreviated to “NIR”. Preferably, the illumination which is used for typical purposes of the present invention is IR radiation, more preferred, NIR radiation, especially of a wavelength of 760 nm to 3 um, preferably of 1 um to 3 um. The illumination may specifically be optical radiation impinging the photodetector, or more specifically the photosensitive region. The term “illumination” may also be referred to as “optical radiation” or as “light” herein.

The illumination may be provided by at least one measurement object, wherein the providing may comprise at least one of a reflecting, transmitting and emitting. Specifically, before interacting with the measurement object, the optical radiation may e.g. be emitted by at least one emitter. The term “emitter” as used herein is a broad term and is to be given its ordinary and customary meaning to a person of ordinary skill in the art and is not to be limited to a special or customized meaning. The term specifically may refer, without limitation, to a device configured for emitting or sending out optical radiation. The emitter may be configured for emitting optical radiation towards the measurement object, such as in form of a light beam. The emitter may be configured for isotopically emitting optical radiation, e.g. uniformly in all spatial directions, wherein only a part of the emitted optical radiation may impinge the measurement object. The emitter may comprise at least one of a semiconductor-based emitter or a thermal radiator. The at least one semiconductor-based emitter may be selected from at least one of a light emitting diode (LED) or a laser, specifically a laser diode. The LED may comprise at least one fluorescent and/or phosphorescent material. The thermal radiator may comprise at least one of an incandescent lamp, a black body emitter and a microelectromechanical system (MEMS) emitter. The emitter may be a modulated emitter. Further kinds of emitters may also be feasible.

The spectrometer housing comprises:
a frame element;
a lid element connected to the frame element;
a separation element arranged within the frame element;
a reflector element arranged on at least a part of one or both of the lid element and the frame element; and
an interface element.

The term “frame element” as used herein is a broad term and is to be given its ordinary and customary meaning to a person of ordinary skill in the art and is not to be limited to a special or customized meaning. The term specifically may refer, without limitation, to a mechanical cover configured for at least partially shielding at least one element, such as at least one neighboring element, e.g. from at least one side. The frame element may specifically be configured for at least partially shielding at least one element from external influences of mechanical nature, e.g. from collisions with further objects and/or from vibrations. The frame element may comprise at least one wall, specifically at least one solid and non-deformable wall. The wall specifically may fully or partially surround at least one interior space in which at least one element may be arranged. The frame element may be configured for at least partially shielding electromagnetic radiation, specifically optical radiation or thermal radiation. The frame element may be or may comprise a support structure configured for holding at least one further element, such as the reflector element.

The term “lid element” as used herein is a broad term and is to be given its ordinary and customary meaning to a person of ordinary skill in the art and is not to be limited to a special or customized meaning. The term specifically may refer, without limitation, to a mechanical cover configured for at least partially shielding at least one element, such as at least one neighboring element, e.g. from at least one side. The lid element may specifically be configured for at least partially shielding at least one element from external influences of mechanical nature, e.g. from collisions with further objects and/or from vibrations. The lid element may comprise at least one wall, specifically at least one solid and non-deformable wall. The wall specifically may fully or partially surround at least one interior space in which at least one element may be arranged. The lid element may be configured for at least partially shielding electromagnetic radiation, specifically optical radiation or thermal radiation. The lid element may be or may comprise a support structure configured for holding at least one further element, such as the reflector element.

As indicated, the frame element and the lid element may be at least one of fully or partially identical, fully or partially integrated into one another, separate from each other, and fully or partially of identical type. The frame element and the lid element may together from one superordinate element, such as a wall, a part of a wall, a surrounding wall or an outer wall of the spectrometer housing configured for at least partially surrounding the spectrometer module, e.g. two or three sides or more sides of the spectrometer module. As an example, the frame element may cover a left side and a back side of the spectrometer module and the lid element may cover a right side and a front side of the spectrometer module, such that an interior of the spectrometer module may laterally be covered from all sides. Further options may be feasible.

As indicated, the lid element is connected to the frame element. The term “connecting” including any grammatical variation thereof as used herein is a broad term and is to be given its ordinary and customary meaning to a person of ordinary skill in the art and is not to be limited to a special or customized meaning. The term specifically may refer, without limitation, to at least one of joining, merging, fitting together and putting together at least two elements, specifically the lid element and the frame element. The connection between the lid element and the frame element may be at least one of form-fit connection, an adhesive connection and a force-fit connection. The connection between the lid element and the frame element may be a fixed or rigid or permanent connection, at least apart from destructive measures. The connection between the lid element and the frame element may be a loose or flexible connection. The lid element may be connected to the frame element at at least one point and/or in at least one region of the spectrometer housing. As an example, the lid element may be connected to the frame element at at least one corner and/or at at least one edge of the spectrometer housing.

The term “separation element” as used herein is a broad term and is to be given its ordinary and customary meaning to a person of ordinary skill in the art and is not to be limited to a special or customized meaning. The term specifically may refer, without limitation, to an element configured for disconnecting or decoupling or separating at least two entities, specifically at least two regions within the spectrometer module. Specifically, the separation element may be configured for fully or partially separating at least one first interior space of the spectrometer module or the housing of the spectrometer module from at least one second interior space of the spectrometer module. Specifically, the separation element may be configured for at least partially preventing light from at least a region of the first interior space entering at least a region of the second interior space or vice a versa. Thus, specifically, the separation element may be fully or partially optically opaque, absorbing or non-transparent, e.g. in the spectral range of sensitivity of the spectrometer module, e.g. in the visible and/or near infrared spectral range as defined above. Specifically, the separation element may be configured for separating the emitter of the spectrometer module form the detector module. The separation element may be configured for blocking, e.g. absorbing, optical radiation, specifically direct optical radiation as emitted by the emitter. The separation element may be configured for shielding the detector from direct optical radiation from the emitter. The separation element may be configured for shielding the detector from straylight, specifically straylight produced within the spectrometer module. Thus, the separation element may be configured for ensuring that the detector is at least predominantly illuminated by optical radiation having interacted with a measurement object.

The term “reflector element” as used herein is a broad term and is to be given its ordinary and customary meaning to a person of ordinary skill in the art and is not to be limited to a special or customized meaning. The term specifically may refer, without limitation, to an element configured for reflecting or deflecting optical radiation. The reflector element may be configured for diffusely and/or regularly reflecting optical radiation, e.g. in one or more of the above-mentioned spectral ranges of the spectrometer module, specifically light, more specifically light in the visible and/or near infrared spectral range. The reflector element may be configured for deflecting an incident light beam in a new direction of propagation different to an incident direction of propagation. The reflector element may have reflective properties for incident optical radiation. The reflector element may comprise at least one reflective surface, such as a metallic surface. The reflector element may specifically have a reflectance of at least 50%, more specifically of at least 60%, more specifically of at least 80%, most specifically of at least 90%, specifically in the visible and/or in the near infrared spectral range. The reflector element may be configured for at least partially guiding optical radiation, such as towards a measurement object and/or around the separation element, specifically by at least partially reflecting the optical radiation. The reflector element may be configured for defining radiance intensity angles, such as for maximizing irradiance of a measurement object. The reflector element may have an arbitrary shape, such as a planar shape or a parabolic shape.

An entrance opening is formed by at least the lid element and the frame element. On a side opposing the entrance opening at least two mounting openings are formed by at least the lid element and the frame element. The at least two mounting openings are separated by the separation element. The frame element and the separation element are integrally formed from the same material.

The term “entrance opening” as used herein is a broad term and is to be given its ordinary and customary meaning to a person of ordinary skill in the art and is not to be limited to a special or customized meaning. The term specifically may refer, without limitation, to an aperture or hole for allowing optical radiation at least one of entering and leaving an element or system. The aperture or hole may be entirely open or, alternatively, may fully or partially be filled and/or covered with at least one transparent material. The entrance opening may comprise or be an aperture or hole formed in the spectrometer housing, such as in at least one wall of the spectrometer housing. The entrance opening may allow optical radiation to enter an interior of the spectrometer housing, specifically for impinging the detector. Additionally or alternatively, the entrance opening may allow optical radiation to leave an interior of the spectrometer housing, specifically optical radiation emitted by the emitter, such as for impinging a measurement object. As an example, the lid element and the frame element may in combination laterally enclose the emitter and the detector, such that an entrance opening is formed above the emitter and the detector. The detector and the emitter may be placed in a bottom part of the spectrometer housing, specifically each in one of the two mounting openings.

The term “mounting opening” as used herein is a broad term and is to be given its ordinary and customary meaning to a person of ordinary skill in the art and is not to be limited to a special or customized meaning. The term specifically may refer, without limitation, to a port or hole configured for at least one of receiving and holding at least one element or system. The mounting opening may be configured for allowing at least one element to be added to a system or to be inserted into a system. The mounting opening may be or may provide at least one of a plugin location and a slot. The mounting opening may be configured for receiving and/or holding the detector of the spectrometer module. The mounting opening may be adapted in a form and/or a size to a form and/or a size of the detector. The mounting opening may be configured for receiving and/or holding the emitter of the spectrometer module. The mounting opening may be adapted in a form and/or a size to a form and/or a size of the emitter. The spectrometer housing may comprise a mounting opening for receiving and/or holding the detector and a further mounting opening for receiving and/or holding the emitter. The mounting openings of the spectrometer housing may be identical, such as identical in a form and/or a size. The mounting openings may, alternatively, also be of different form and/or size. As an example, the mounting opening may be covered by an optical window, such as by a window made of glass and/or SI, for example further comprising a coating for controlling at least one optical property of the optical window.

As said, the frame element and the separation element are integrally formed from the same material. As further indicated before, the separation element is arranged within the frame element. The separation element may be connected to the frame element, such as in at least one point, specifically permanently or indivisibly, at least apart from destructive measures. The separation element and the frame element may be formed from the same material in one common manufacturing process, such as in a molding process, e.g. an injection molding process, or printing process, e.g. 3D printing. The frame element and the separation element may form one superordinate element. Thus, the frame element and the separation element may each correspond to a part of the superordinate element. Specifically, e.g. from an outside perspective, the frame element and the separation element may form one element. In other words, specifically to the outside, the frame element and the separation element may be one element or may appear as one element.

The reflector element may be secured to one or both of the lid element and the frame element, specifically to an inner surface of one or both of the lid element and the frame element. The reflector element may be secured by one or more of a form-fit connection, an adhesive connection and a force-fit connection. The term “securing” including any grammatical variation thereof as used herein is a broad term and is to be given its ordinary and customary meaning to a person of ordinary skill in the art and is not to be limited to a special or customized meaning. The term specifically may refer, without limitation, to at least one of fixing, attaching, mounting and fastening at least one element to at least one further element. The term may further refer to at least one of connecting, combining and merging at least one element with at least one further element. A variety of different options for securing the reflector element to one or both of the lid element and the frame element may be feasible and is generally known to the skilled person. Additionally or alternatively, the reflector element may be or may comprise a metallized surface, for example applied to the lid element and/or the frame element by using one or more deposition technologies, such as sputtering, coating and evaporation.

The lid element and the frame element may be integrally formed from the same material. The lid element may be connected to the frame element, such as in at least one point, specifically permanently or indivisibly, at least apart from destructive measures. The lid element and the frame element may be formed from the same material in one common manufacturing process, such as in a molding process, e.g. an injection molding process, or in a printing process, e.g. 3D printing. The frame element and the lid element may form one superordinate element. Thus, the frame element and the lid element may each correspond to a part of the superordinate element. Specifically, e.g. from an outside perspective, the frame element and the lid element may form one element. In other words, specifically to the outside, the frame element and the lid element may be one element or may appear as one element. The lid element and the frame element may form one element or cover configured for at least partially covering the spectrometer module. As an example, the lid element and the frame element may form one element or cover configured for covering the spectrometer from all sides apart from the entrance opening and the at least two mounting openings.

The lid element may comprise at least one metal material. The metal material may comprise at least one surface configured for at least partially reflecting optical radiation. Thus, the lid element may be configured for at least partially reflecting optical radiation. Thus, the lid element may be configured for guiding optical radiation or, in other words, for providing a light guiding function. As an example, at least one region of at least one surface of the lid element may be configured for reflecting optical radiation. The lid element may comprise the reflector element.

The lid element and the reflector element may be the same element. As an example, the lid element may be at least partially metallized for forming the reflector element. Specifically, at least one surface of the lid element may be metallized for forming the reflector element. The reflector element may comprise at least one metal material selected from the group consisting of: gold, silver, aluminum and any other metal suitable for the generation of metallized surfaces, e.g. any alloys. Specifically, the reflector element may be an arbitrary metal material with a high reflectance of at least 50%, more specifically of at least 60%, more specifically of at least 80%, most specifically of at least 90%, specifically in the visible and/or in the near infrared spectral range. As an example, the metal material forming the reflector element may be applied to the lid element by using one or more deposition technologies, such as sputtering, coating and evaporation.

The spectrometer housing further comprises an interface element, wherein the interface element is configured for covering the entrance opening. The term “interface element” as used herein is a broad term and is to be given its ordinary and customary meaning to a person of ordinary skill in the art and is not to be limited to a special or customized meaning. The term specifically may refer, without limitation, to an element configured for at least one of coupling optical radiation out of the spectrometer module and for coupling optical radiation into the spectrometer module. Specifically, the interface element may be configured for transmitting optical radiation, at least in a spectral range emitted by the emitter of the spectrometer module. The interface element may be or may comprise one or more of a fully or partially transparent material, a glass material, a silicon material, a material having non-absorbing properties in an infrared spectrum, a long-pass filter material, a material having filtering properties in one or more of a visual-spectrum and an ultraviolet-spectrum. Other options are feasible.

The frame element and the separation element, and optionally the lid element, may comprise at least one material selected from the group consisting of: a polycarbonate material, an epoxy resin material, a metal material, and any other materials that can be manufactured to form the elements by molding or printing technologies. At least one surface of the frame element and the separation element, and optionally the lid element, may be configured for reflecting less than 6%, of light emitted by the emitter and impinging on the surface. The at least one surface may specifically show a black color or have a black color. As an example, the elements or the at least one surface may be coated or died, such as to resemble a black color. The separation element may be configured for blocking of light emitted from the emitter from transmitting through the separation element, specifically blocking a direct light path between the emitter and the detector so that the transmittance spectrum may be in the measurable noise level, i.e. within a noise level that is able to be measured, more specifically, the transmittance T may be ≤10⁻¹, more specifically 10⁻¹, ≤T≤10⁻⁵, more specifically, 10⁻²≤T≤10⁻⁴. In particular, the transmission T may refer to a quotient of the spectral flux behind the separation element, i.e. on a detector side of the separation element, and the spectral flux in front of the separation element, i.e. on an emitter side of the separation element. The separation element may be arranged such that a direct beam path between the emitter and the detector is blocked. Thus, the separation element may prevent optical radiation from reaching the detector before interaction with a measurement object, such as before a reflection at the measurement object. The reflector element may be configured for at least partially reflecting light emitted by the emitter. The reflector element may be configured and/or arranged for reflecting light emitted by the emitter at least partially towards the interface element and further towards a measurement object. The reflector element may be configured for assisting the optical radiation emitted by the emitter in bypassing the separation element for reaching the detector. The reflector element may be configured for at least partially guiding the optical radiation, specifically around the separation element.

At least one first opening of the at least two mounting openings may be configured for forming part of a detector compartment for receiving the detector and at least one second opening of the at least two mounting openings may be configured for forming part of an emitter compartment for receiving the emitter. The term “compartment” as used herein is a broad term and is to be given its ordinary and customary meaning to a person of ordinary skill in the art and is not to be limited to a special or customized meaning. The term specifically may refer, without limitation, to a space configured for receiving at least one element. The compartment may comprise at least one cavity for receiving at least one element or at least a part of an element. A geometric form of the compartment may be adapted to a geometric form of the element or at least for the part of the element to be received. As an example, the compartment may be or comprise a partially open chamber, such as a chamber open to the top and/or bottom. The term “detector compartment” as used herein is a broad term and is to be given its ordinary and customary meaning to a person of ordinary skill in the art and is not to be limited to a special or customized meaning. The term specifically may refer, without limitation, to a compartment configured for receiving at least one detector. The detector compartment may comprise a geometric form adapted to a geometric form of the at least one detector, such that the at least one detector may specifically be tightly incorporated into the detector compartment. The term “emitter compartment” as used herein is a broad term and is to be given its ordinary and customary meaning to a person of ordinary skill in the art and is not to be limited to a special or customized meaning. The term specifically may refer, without limitation, to a compartment configured for receiving at least one emitter. The emitter compartment may comprise a geometric form adapted to a geometric form of the at least one emitter, such that the at least one emitter may specifically be tightly incorporated into the emitter compartment.

The spectrometer housing may be dimensioned to fit within a cuboid having a volume v≤1.5cm³, specifically v≤1.125 cm³, more specifically v≤0.9 cm³, more specifically v≤0.5 cm³. As an example, the spectrometer housing may have the dimensions 1.5 cm×1.5 cm×0.5 cm or 1 cm×1 cm×0.5 cm. Thus, the spectrometer housing may be a miniaturized spectrometer housing. Such dimensions may allow integration of the spectrometer housing into consumer electronics, such as smartphones, wearables, or tablets. The spectrometer housing may be configured for integration into consumer electronics, such as smartphones, wearables, or tablets.

In a further aspect of the present invention, a spectrometer module is disclosed. The spectrometer module comprises at least one detector, at least one emitter and at least one spectrometer housing according to any one of the embodiments disclosed above or below in further detail referring to a spectrometer housing.

The spectrometer module may further comprise at least one substrate, specifically a circuit carrier, more specifically a printed circuit board. Specifically, one or more of the emitter, the detector, corresponding ICs such as drivers, filters, passive components and the spectrometer housing may be arranged on the substrate. The emitter may be enclosed within a first of the at least two mounting openings of the spectrometer housing. The detector may be enclosed within a second of the at least two mounting openings of the spectrometer housing. The term “substrate” as used herein is a broad term and is to be given its ordinary and customary meaning to a person of ordinary skill in the art and is not to be limited to a special or customized meaning. The term specifically may refer, without limitation, to an arbitrary element designed to carry one or more other elements disposed thereon and/or therein. The substrate may be a planar substrate.

The substrate may, specifically, have a planar shape, such as the shape of a rectangular plate, e.g. a printed circuit board plate, e.g. fully or partially made of at least one electrically insulating material, e.g. at least one plastic material, such as a resin and/or a fiber reinforced plastic material. The substrate in general may have a thickness of less than 1 mm, e.g. 0.6 mm or less or 0.4 mm or less. The substrate may comprise one or more layers, specifically thin layers, such as layers having a thickness of 0.5 mm or less. Other sizes and/or forms may also be feasible.

The term “circuit carrier” as used herein is a broad term and is to be given its ordinary and customary meaning to a person of ordinary skill in the art and is not to be limited to a special or customized meaning. The term specifically may refer, without limitation, to a substrate configured for carrying electrically conducting elements. The circuit carrier may specifically comprise at least partially, or even completely, at least one electrically insulating material, especially in order to avoid unwanted currents between electrically conducting elements as carried by the circuit carrier. By way of example, the electrically insulating material may be selected from polyethylene terephthalate (PET) or polycarbonate (PC); however, other kinds of electrically insulating materials may also be feasible.

The term “printed circuit board”, typically abbreviated by “PCB”, as used herein is a broad term and is to be given its ordinary and customary meaning to a person of ordinary skill in the art and is not to be limited to a special or customized meaning. The term specifically may refer, without limitation, to an electrically non-conductive, planar substrate, also denoted as “board”, on which at least one sheet of an electrically conductive material, such as a copper layer, is applied, specifically laminated, to the substrate, and which, in addition, comprises one or more electronic, electrical, and/or optical elements. The board may be or may comprise at least one substrate and/or at least one circuit carrier as defined above, as well as optionally one or more electrically conducting paths, also referred to as tracks or traces, disposed thereon and/or therein, and/or one or more through holes. Other terms which refer to this type of circuit carrier are printed circuit assembly, short “PCA”, printed circuit board assembly, short “PCB assembly” or “PCBA”, circuit card assembly, short “CCA”, or simply “card”. In the PCB, the electrically insulating substrate may comprise a glass epoxy, wherein a cotton paper impregnated with a phenolic resin, typically tan or brown, may also be used as substrate material. Depending on a number of sheets, the printed circuit board may be a single-sided PCB, a two-layer or double-sided PCB, or a multi-layer PCB, wherein different sheets may be connected with each other by using so-called “vias”. A double-sided PCB may have metal on both sides, while a multi-layer PCB may be designed by sandwiching additional metal layers between further layers of electrically insulating material. Further, by using two double-sided PCBs, a four-layer PCB or more layers on PCB may be generated. In a multi-layer PCB, the layers can be laminated together in an alternating manner, such as in an order of metal, substrate, metal, substrate, metal, etc., wherein each metal layer may be individually etched and wherein any internal vias may be plated through before the multiple layers are laminated together. Further, the vias may be or comprise copper-plated holes which can, preferably, be designed as electrical tunnels through the electrically insulating substrate. For this purpose, through-hole components may also be used which may, usually, be mounted by wire leads passing through the substrate and soldered to tracks or traces on the other side.

The spectrometer module may be dimensioned to fit within a cuboid having a volume v≤1.5 cm³, specifically v≤1.125 cm³, more specifically v≤0.9 cm³, more specifically v≤0.864 cm³, more specifically v≤0.5 cm³. As an example, the spectrometer housing may have the dimensions 1.5 cm×1.5 cm×0.5 cm or 1 cm×1 cm×0.5 cm. Thus, the spectrometer module may be a miniaturized spectrometer module. Such dimensions may allow integration of the spectrometer module into consumer electronics, such as smartphones, wearables or tablets. The spectrometer module may be configured for integration into consumer electronics, such as smartphones, wearables, or tablets.

The spectrometer may comprise at least one optical filter element. The optical filter element may be configured for filtering the optical radiation or more specifically at least one selected spectral range of the optical radiation. The at least one optical filter element may specifically be positioned in a light path before the detector.

For further definitions and embodiments regarding the spectrometer module, reference may be made to the description of the spectrometer housing above.

In a further aspect of the present invention, a method of manufacturing at least one spectrometer housing configured for at least partially enclosing a detector and an emitter of a spectrometer module is disclosed. The method comprises:
a) integrally forming a frame element and a separation element;
b) providing a lid element, wherein the lid element and the frame element form an entrance opening and at least two mounting openings and wherein the mounting openings are separated by the separation element;
c) depositing a reflector element on at least part of one or both of the lid element and the frame element.

The method steps may be performed in the indicated order. It shall be noted, however, that a different order is also possible. The method may comprise further method steps, which are not listed. Further, one or more of the method steps may be performed once or repeatedly. Further, two or more of the method steps may be performed simultaneously or in a timely overlapping fashion.

In step a), the frame element and the separation element may be formed as one element. In other words, the frame element and the separation element may be formed in one piece. The separation element and the frame element may be formed from the same material in one common manufacturing process, such as in a molding or printing process, e.g. an injection molding process or 3D-printing process, as will also be outlined in further detail below. In step b), the lid element may be arranged with respect to the frame element such that the lid element and the frame element form the entrance opening and the at least two mounting openings. Further, the lid element may be arranged with respect to the separation element such that the mounting openings are separated by the separation element. As an example, the lid element may be arranged such that the separation element is essentially positioned in a center of the spectrometer housing. In step c), the reflector element may specifically be deposited on at least one surface of one or both of the lid element and the frame element.

Step c) may further comprise securing the reflector element to an inner surface of one or both of the lid element and the frame element. Step c) may comprise one or more of molding, mounting and gluing the reflector element to one or both of the lid element and the frame element, specifically to an inner surface of one or both of the lid element and the frame element. Step c) may comprise at least partially metallizing the inner surface of one or both of the lid element and the frame element. Specifically, step c) may comprise selectively metallizing at least a part of the inner surface of one or both of the lid element and the frame element. The metallizing may comprise a coating with at least one metal or alloy material. The metallizing may comprise applying an external voltage or heat. The metallizing may comprise a vacuum deposition, e.g. a chemical vapor deposition or a physical vapor deposition. A variety of different deposition methods may be feasible and are generally known to the skilled person.

The lid element and the frame element may be formed integrally, specifically by a molding process. The term “molding process” as used herein is a broad term and is to be given its ordinary and customary meaning to a person of ordinary skill in the art and is not to be limited to a special or customized meaning. The term specifically may refer, without limitation, to a process of shaping a liquid, liquefied or pasty material by inserting, e.g. injecting, the liquid, liquefied or pasty material into a rigid frame, wherein the rigid frame is typically referred to as mold or matrix. As an example, the mold may be a hollowed-out block, which may be filled with the liquid material, e.g. a synthetic plastic material or a metal material, whereupon the liquid may harden inside the mold, adopting a corresponding form. A variety of different molding methods may be feasible and are generally known to the skilled person. One or more of steps a) and b), may comprise performing a molding process selected from the group consisting of: an injection molding process, a low pressure molding process, a compression molding process, a transfer molding process, a film-assisted molding process, i.e. a film-assisted selective molding process, a thermoforming process, and a rotational molding process. As an example, at least one of the frame element, the separation element and the lid element may be formed by using an injection molding process, e.g. a plastics injection molding process or a metal injection molding process. Step b) may further comprise providing the reflector element. The reflector element and the lid element may be the same element, may be fully or partially identical or may be fully or partially integrated into one another. As indicated, at least one surface of the lid element may for instance be metallized.

The method may further comprise:
d) providing an interface element and covering the entrance opening with the interface element.

The method may be configured for manufacturing the spectrometer housing according to any one of the embodiments disclosed above or below in further detail referring to a spectrometer housing.

For further definitions and embodiments regarding the method, reference may be made to the description of the spectrometer housing or the spectrometer module above.

In a further aspect of the present invention, a method of manufacturing a spectrometer module is disclosed. The method comprises:
i) performing the method of manufacturing at least one spectrometer housing according to any one of the embodiments described above or below referring to a method of manufacturing a spectrometer housing;
ii) providing at least one emitter and at least one detector on at least one substrate, specifically on a circuit carrier, more specifically on a printed circuit board;
iii) arranging the spectrometer housing on the at least one substrate, such that the emitter is enclosed within a first of the at least two mounting openings, specifically within an emitter compartment, of the spectrometer housing and the detector is enclosed within a second of the at least two mounting openings, specifically within a detector compartment, of the spectrometer housing.

The method steps may be performed in the indicated order. It shall be noted, however, that a different order is also possible. The method may comprise further method steps which are not listed. Further, one or more of the method steps may be performed once or repeatedly. Further, two or more of the method steps may be performed simultaneously or in a timely overlapping fashion.

Step iii) specifically may comprise securing the spectrometer housing to the substrate by material engagement. Specifically, step iii) may further comprise securing the spectrometer housing to the substrate by performing a bonding process selected from the group consisting of: gluing and soldering. The term “bonding process” as used herein is a broad term and is to be given its ordinary and customary meaning to a person of ordinary skill in the art and is not to be limited to a special or customized meaning. The term specifically may refer, without limitation, to a method for joining or connecting at least two elements. The bonding process may comprise inserting at least one filler material into the joint of the elements, such as glue or a filler metal, e.g. soldering tin. The bonding process may comprise heating the elements. The bonding process may comprise at least one pre-treatment of the elements before joining the elements, such as a surface modification, e.g. a cleaning or a drying. A variety of different bonding processes may be feasible and are generally known to the skilled person.

The method may be configured for manufacturing the spectrometer module according to any one of the embodiments disclosed above or below in further detail referring to a spectrometer module.

For further definitions and embodiments regarding the method of manufacturing a spectrometer module, reference may be made to the description of the method of manufacturing a spectrometer housing, the spectrometer housing or the spectrometer module above.

The devices and methods as disclosed herein have considerable advantages over the prior art. Specifically, the disclosed devices and methods may allow an integration of a spectrometer module into consumer electronics, such as into a smartphone, into a wearable, or into a tablet. The spectrometer module may be a miniaturized spectrometer module. The spectrometer housing of the spectrometer module may be a miniaturized spectrometer housing. The spectrometer housing may be suitable for chip-size spectrometer modules. The spectrometer housing comprising a reflector element may further be configured for guiding optical radiation and defining radiance intensity angles, such as for maximizing irradiance of a measurement object. The spectrometer housing may be producible by using mass production techniques, such as molding processes, e.g. injection molding processes. Thus, the spectrometer module may also be cost effective and flexible in design.

As used herein, the terms “have”, “comprise” or “include” or any arbitrary grammatical variations thereof are used in a non-exclusive way. Thus, these terms may both refer to a situation in which, besides the feature introduced by these terms, no further features are present in the entity described in this context and to a situation in which one or more further features are present. As an example, the expressions “A has B”, “A comprises B” and “A includes B” may both refer to a situation in which, besides B, no other element is present in A (i.e. a situation in which A solely and exclusively consists of B) and to a situation in which, besides B, one or more further elements are present in entity A, such as element C, elements C and D or even further elements.

Further, it shall be noted that the terms “at least one”, “one or more” or similar expressions indicating that a feature or element may be present once or more than once typically are used only once when introducing the respective feature or element. In most cases, when referring to the respective feature or element, the expressions “at least one” or “one or more” are not repeated, notwithstanding the fact that the respective feature or element may be present once or more than once.

Further, as used herein, the terms “preferably”, “more preferably”, “particularly”, “more particularly”, “specifically”, “more specifically” or similar terms are used in conjunction with optional features, without restricting alternative possibilities. Thus, features introduced by these terms are optional features and are not intended to restrict the scope of the claims in any way. The invention may, as the skilled person will recognize, be performed by using alternative features. Similarly, features introduced by “in an embodiment of the invention” or similar expressions are intended to be optional features, without any restriction regarding alternative embodiments of the invention, without any restrictions regarding the scope of the invention and without any restriction regarding the possibility of combining the features introduced in such way with other optional or non-optional features of the invention.

Summarizing and without excluding further possible embodiments, the following embodiments may be envisaged:

Embodiment 1: A spectrometer housing configured for at least partially enclosing at least one detector and at least one emitter of a spectrometer module, the spectrometer housing comprising:
a frame element;
a lid element connected to the frame element;
a separation element arranged within the frame element;
a reflector element arranged on at least a part of one or both of the lid element and the frame element, and
an interface element,
wherein an entrance opening is formed by at least the lid element and the frame element, wherein on a side opposing the entrance opening at least two mounting openings are formed by at least the lid element and the frame element, the at least two mounting openings being separated by the separation element, and wherein the frame element and the separation element are integrally formed from the same material, wherein the interface element is configured for covering the entrance opening.

Embodiment 2: The spectrometer housing according to the preceding embodiment, wherein the reflector element is secured to one or both of the lid element and the frame element, specifically to an inner surface of one or both of the lid element and the frame element.

Embodiment 3: The spectrometer housing according to the preceding embodiment, wherein the reflector element is secured by one or more of a form-fit connection, an adhesive connection and a force-fit connection.

Embodiment 4: The spectrometer housing according to any one of the preceding embodiments, wherein the lid element and the frame element are integrally formed from the same material.

Embodiment 5: The spectrometer housing according to any one of embodiments 1 to 3, wherein the lid element comprises at least one metal material.

Embodiment 6: The spectrometer housing according to the preceding embodiment, wherein the lid element and the reflector element are the same element.

Embodiment 7: The spectrometer housing according to any one of the preceding embodiments, wherein the reflector element comprises a metal material selected from the group consisting of: gold, silver, aluminum and any other metal suitable for the generation of metallized surfaces, e.g. any alloys.

Embodiment 8: The spectrometer housing according to any one of the preceding embodiments, wherein the frame element and the separation element, and optionally the lid element, comprise at least one material selected from the group consisting of: a polycarbonate material, an epoxy resin material, a metal material, and any other materials that can be manufactured to form the elements by molding or printing technologies.

Embodiment 9: The spectrometer housing according to any one of the preceding embodiments, wherein at least one surface of the frame element and the separation element, and optionally the lid element, is configured for reflecting less than 6%, of light emitted by the emitter and impinging on the surface.

Embodiment 10: The spectrometer housing according to any one of the preceding embodiments, wherein the separation element is configured for blocking of light emitted from the emitter from transmitting through the separation element, specifically blocking a direct light path between the emitter and the detector so that the transmittance spectrum is in the measureable noise level, more specifically the transmittance T is ≤10⁻¹, more specifically 10⁻¹, ≤T≤10⁻⁵, more specifically 10^{31 2}, ≤T≤10⁻⁴.

Embodiment 11: The spectrometer housing according to any one of the preceding embodiments, wherein the reflector element is configured for at least partially reflecting light emitted by the emitter.

Embodiment 12: The spectrometer housing according to any one of the preceding embodiments, wherein a first of the at least two mounting openings is configured for forming part of a detector compartment for receiving the detector and a second of the at least two mounting openings is configured for forming part of an emitter compartment for receiving the emitter.

Embodiment 13: The spectrometer housing according to any one of the preceding embodiments, wherein the spectrometer housing is dimensioned to fit within a cuboid having a volume v≤1.5 cm³, specifically v≤1.125 cm³, more specifically v≤0.9 cm³, more specifically v≤0.5 cm³.

Embodiment 14: A spectrometer module comprising at least one detector, at least one emitter and at least one spectrometer housing according to any one of the preceding embodiments referring to a spectrometer housing.

Embodiment 15: The spectrometer module according to the preceding embodiment, wherein the spectrometer module further comprises at least one substrate, specifically a circuit carrier, more specifically a printed circuit board, wherein the emitter, the detector and the spectrometer housing are arranged on the substrate, wherein the emitter is enclosed within a first of the at least two mounting openings of the spectrometer housing and wherein the detector is enclosed within a second of the at least two mounting openings of the spectrometer housing.

Embodiment 16: The spectrometer module according to any one of the preceding embodiments referring to a spectrometer module, wherein the spectrometer module is dimensioned to fit within a cuboid having a volume v≤1.5 cm³, specifically v≤1.125 cm³, more specifically v≤0.9 cm³, more specifically v≤0.5 cm³.

Embodiment 17: A method of manufacturing at least one spectrometer housing configured for at least partially enclosing a detector and an emitter of a spectrometer module, the method comprising:
a) integrally forming a frame element and a separation element;
b) providing a lid element, wherein the lid element and the frame element form an entrance opening and at least two mounting openings and wherein the mounting openings are separated by the separation element;
c) depositing a reflector element on at least part of one or both of the lid element and the frame element.

Embodiment 18: The method according to the preceding embodiment, wherein step c) further comprises securing the reflector element to an inner surface of one or both of the lid element and the frame element.

Embodiment 19: The method according to the preceding embodiment, wherein step c) comprises one or more of molding, mounting and gluing the reflector element to one or both of the lid element and the frame element, specifically to an inner surface of one or both of the lid element and the frame element.

Embodiment 20: The method according to any one of the preceding method embodiments, wherein the lid element and the frame element are formed integrally, specifically by a molding process.

Embodiment 21: The method according to any one of the preceding method embodiments, wherein one or more of steps a) and b), comprise performing a molding process selected from the group consisting of: an injection molding process, a low pressure molding process, a compression molding process, a transfer molding process, a film-assisted molding process, i.e. a film-assisted selective molding process, a thermoforming process, and a rotational molding process.

Embodiment 22: The method according to any one of embodiments 18 to 20, wherein step b) further comprises providing the reflector element, wherein the reflector element and the lid element are the same element.

Embodiment 23: The method according to any one of the preceding method embodiments, wherein the method further comprises:
d) providing an interface element and covering the entrance opening with the interface element.

Embodiment 24: The method according to any one of the preceding method embodiments, wherein the method is configured for manufacturing the spectrometer housing according to any one of the preceding embodiments referring to a spectrometer housing.

Embodiment 25: A method of manufacturing a spectrometer module, the method comprising:
i) performing the method of manufacturing at least one spectrometer housing according to any one of the preceding method embodiments;
ii) providing at least one emitter and at least one detector on at least one substrate, specifically on a circuit carrier, more specifically on a printed circuit board;
iii) arranging the spectrometer housing on the at least one substrate, such that the emitter is enclosed within a first of the at least two mounting openings, specifically within an emitter compartment, of the spectrometer housing and the detector is enclosed within a second of the at least two mounting openings, specifically within a detector compartment, of the spectrometer housing

Embodiment 26: The method according to the preceding embodiment, wherein step iii) further comprises securing the spectrometer housing to the substrate by performing a bonding process selected from the group consisting of: gluing and soldering.

Embodiment 27: The method according to any one of the two preceding embodiments, wherein the method is configured for manufacturing the spectrometer module according to any one of the preceding embodiments referring to a spectrometer module.

### SHORT DESCRIPTION OF THE FIGURES

Further optional features and embodiments will be disclosed in more detail in the subsequent description of embodiments, preferably in conjunction with the dependent claims. Therein, the respective optional features may be realized in an isolated fashion as well as in any arbitrary feasible combination, as the skilled person will realize. The scope of the invention is not restricted by the preferred embodiments. The embodiments are schematically depicted in the Figures. Therein, identical reference numbers in these Figures refer to identical or functionally comparable elements.

In the Figures:

FIG. 1 shows a schematic view of an exemplary embodiment of a spectrometer module;

FIG. 2 shows a schematic view of a further exemplary embodiment of a spectrometer module;

FIG. 3 shows an exemplary embodiment of a spectrometer housing;

FIG. 4 shows a flow chart of an embodiment of a method of manufacturing a spectrometer housing; and

FIG. 5 shows a flow chart of an embodiment of a method of manufacturing a spectrometer.

### DETAILED DESCRIPTION OF THE EMBODIMENTS

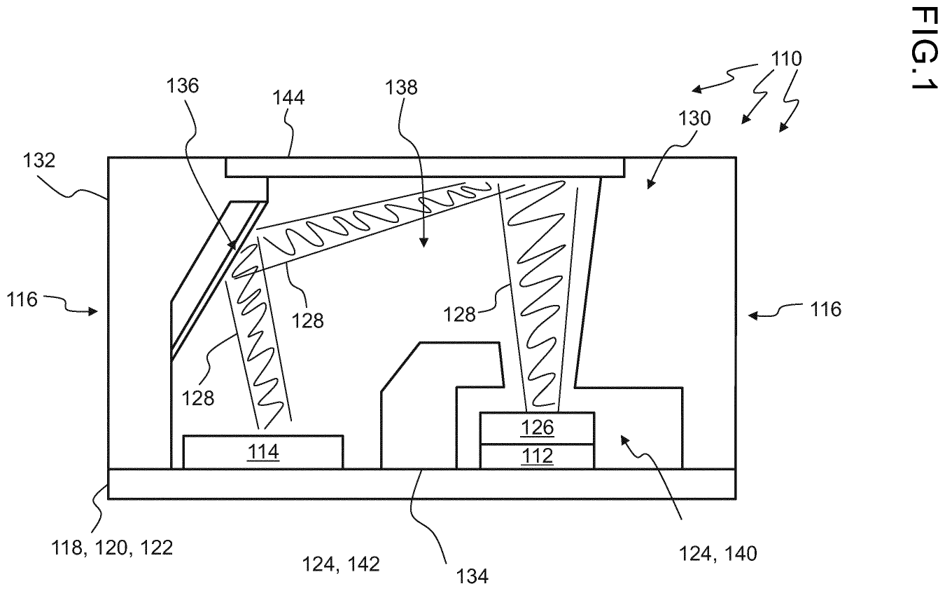

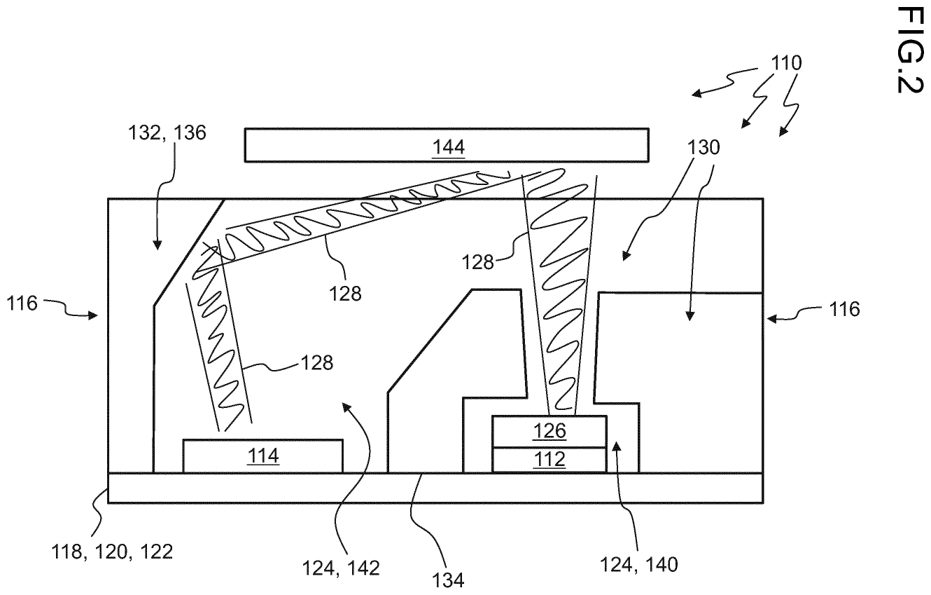

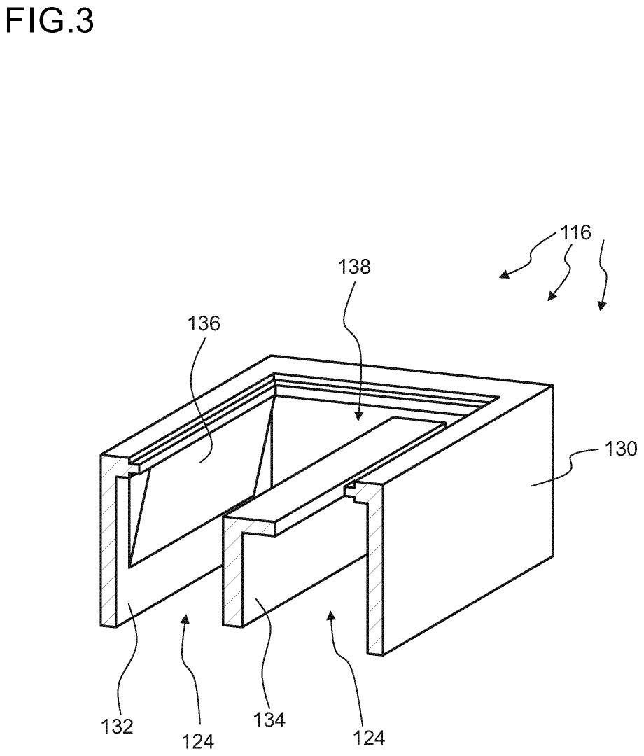

FIG. 1 shows a schematic view of an exemplary embodiment of a spectrometer module 110. The spectrometer module 110 comprises at least one detector 112, at least one emitter 114 and at least one spectrometer housing 116 according to any one of the embodiments described above or below in further detail referring to the spectrometer housing 116. With respect to the spectrometer housing 116 of the spectrometer module 110, reference may also specifically be made to FIG. 3, which shows an exemplary embodiment of the spectrometer housing 116 in an isolated fashion. FIG. 2 shows a schematic view of a further exemplary embodiment of the spectrometer module 110. Thus, at least in many aspects, FIG. 1 and FIG. 2 can be described in conjunction. Further, with respect to the spectrometer housing 116 in particular, at least in many aspects, FIG. 1 to FIG. 3 can and will be described in conjunction in the following.

The spectrometer module 110 may further comprise at least one substrate 118, specifically a circuit carrier 120, more specifically a printed circuit board 122. The emitter 114, the detector 112 and optionally also the spectrometer housing 116 may be arranged on the substrate 118. The emitter 114 may be enclosed within a first of at least two mounting openings 124 of the spectrometer housing 116 and the detector 112 may be enclosed within a second of the at least two mounting openings 124 of the spectrometer housing 116. The spectrometer module 110 may comprise at least one optical filter element 126 and/or any other type of wavelength-selective element. The optical filter element 126 may be configured for filtering light 128 or more specifically at least one selected spectral range of the light 128. The at least one optical filter element 126 may specifically be positioned in a light path before the detector 112. Thus, the optical filter element 126 may at least partially cover the detector 112. The spectrometer module 110 may be dimensioned to fit within a cuboid having a volume v≤1.5 cm³, specifically v≤1.125 cm³, more specifically v≤0.9 cm³, more specifically v≤0.5 cm³. As an example, the spectrometer housing may have the dimensions 1.5 cm×1.5 cm×0.5 cm or 1 cm×1 cm×0.5 cm. Thus, the spectrometer module 110 may be miniaturized. Such dimensions may specifically allow integration of the spectrometer module 110 into consumer electronics, such as smartphones, wearables or tablets.

The spectrometer housing 116 is configured for at least partially enclosing the at least one detector 112 and the at least one emitter 114 of the spectrometer module 110. The spectrometer housing 116 comprises a frame element 130. The spectrometer housing 116 comprises a lid element 132 connected to the frame element 130. The spectrometer housing 116 comprises a separation element 134 arranged within the frame element 130. The spectrometer housing 116 comprises a reflector element 136 arranged on at least a part of one or both of the lid element 132 and the frame element 130. An entrance opening 138 is formed by at least the lid element 132 and the frame element 130. On a side opposing the entrance opening 138 the at least two mounting openings 124 are formed by at least the lid element 132 and the frame element 130. The at least two mounting openings 124 are separated by the separation element 134. The frame element 130 and the separation element 134 are integrally formed from the same material.

The lid element 132 and the frame element 130 may integrally be formed from the same material. As FIG. 3 indicates for instance, the frame element 130, the lid element 132 and the separation element 134 may be integrally formed from the same material, e.g. by using a molding process, such as an injection molding process, as will also be described below. The frame element 130 and the separation element 134, and optionally the lid element 132, may comprise at least one material selected from the group consisting of: a polycarbonate material, an epoxy resin material, a metal material, or any other materials that can be manufactured to form the elements by molding or printing technologies. At least one surface of the frame element 130 and the separation element 134, and optionally the lid element 132, may be configured for reflecting less than 6%, of light 128 emitted by the emitter 114 and impinging on the surface. The frame element 130 and the lid element 132 may laterally surround the detector 112 and the emitter 114 of the spectrometer module 110. Thus, the frame element 130 and the lid element 132 may at least partially mechanically cover the spectrometer module 110. The separation element 134 may be centrally positioned in the spectrometer module 110, specifically between the detector 112 and the emitter 114 as FIG. 1 and FIG. 2 indicate. The separation element 134 may be configured for blocking of light 128 emitted from the emitter 114 from transmitting through the separation element 130, specifically blocking a direct light path between the emitter 114 and the detector 112, for example in such a way that the transmittance spectrum is within the noise level that is able to be measured, for example, the transmittance T should be in the order of 10⁻² to 10⁻⁴, i.e. 10⁻², ≤T≤10⁻⁴.

The at least two mounting openings 124 may be formed by the frame element 130, the lid element 132 and the separation element 134, e.g. by using the arrangement described above. A first of the at least two mounting openings 124 may be configured for forming part of a detector compartment 140 for receiving the detector 112 and a second of the at least two mounting openings 124 may be configured for forming part of an emitter compartment 142 for receiving the emitter 114. The spectrometer housing 116 may be dimensioned to fit within a cuboid having a volume v≤1.5 cm³, specifically v≤1.125 cm³, more specifically v≤0.9 cm³, more specifically v≤0.5 cm³. As an example, the spectrometer housing 116 may have the dimensions 1.5 cm×1.5 cm×0.5 cm or 1 cm×1 cm×0.5 cm. Thus, the spectrometer housing 116 may be miniaturized, specifically for integration of the spectrometer module 110 into consumer electronics.

The spectrometer housing 116 further comprises an interface element 144 configured for covering the entrance opening 138. In particular, the interface element may be positioned directly contacting the frame element 130, as exemplarily indicated in FIG. 1, or may be positioned at a distance from the frame element 130, as exemplarily indicated in FIG. 2. As an example, the interface element 144, besides being part of the spectrometer housing 116, may also be a part of the spectrometer module 110, such as a part of a cover glass on a smartphone, tablet or wearable.

As said, the spectrometer housing 116 comprises the reflector element 136. The reflector element 136 may be configured for at least partially reflecting the light 128 emitted by the emitter 114. The reflector element 136 may comprise a metal material selected from the group consisting of: gold, silver, aluminum, and any alloys. The reflector element 136 may be secured to one or both of the lid element 132 and the frame element 130, specifically to an inner surface of one or both of the lid element 132 and the frame element 130. The reflector element 136 may be secured by one or more of a form-fit connection, an adhesive connection and a force-fit connection. As FIG. 1 indicates, the reflector element 136 may for instance be connected to an inner surface of the lid element 132. Further, the lid element 132 and the reflector element 136 may be the same element, as for instance indicated in FIG. 2. For example in this case, the lid element 132 and the frame element 130 may not be integrally formed from the same material. The lid element 132 may comprise at least one metal material. As an example, the lid element 132 may be formed by using a molding process using a metal material and the frame element 130 may be formed by using a molding process using a synthetic plastic material. As a further example, an inner surface of the lid element 132 may be metallized.

With respect to FIG. 1 and FIG. 2, a light path of the light 128 will be described in the following. The light 128 may be emitted by using the emitter 114, specifically at least partially towards the reflector element 136. As already described, a direct light path to the detector 112 may be blocked by the separation element 134. From the reflector element 136, the light 128 may at least partially be reflected towards the interface element 144. The light 128 may at least partially be transmitted through the interface element 144. The light 128 may at least partially be reflected by the interface element 144. Specifically, the light 128 may interact with a measurement object, which may be positioned on top of the interface element 144, i.e. on a surface of the interface element 144 facing away from the detector 112 and the emitter 114. Specifically, the light 128 that has at least partially interacted with the measurement object may be indicative of at least one physical property of the measurement object. As an example, a spectral absorption of the light 128 may be indicative of a chemical composition of the measurement object. The measurement object may at least partially reflect the light 128, specifically at least partially towards the detector 112 covered by the optical filter element 126. The detector 112 may transmit a corresponding signal, e.g. an electronic signal, to the printed circuit board 122 for further processing, evaluation and/or transmission to further devices.

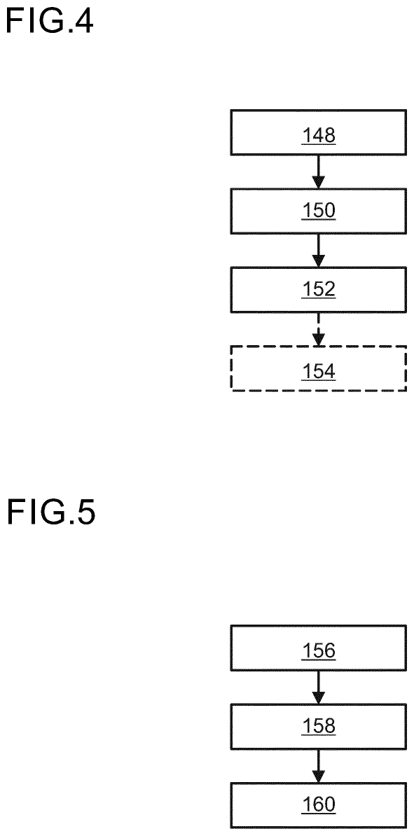

FIG. 4 shows a flow chart of an embodiment of a method of manufacturing the spectrometer housing 116 configured for at least partially enclosing the detector 112 and the emitter 114 of the spectrometer module 110. The method comprises:
a) (denoted with reference number 148) integrally forming the frame element 130 and the separation element 134;
b) (denoted with reference number 150) providing the lid element 132, wherein the lid element 132 and the frame element 130 form the entrance opening 138 and the at least two mounting openings 124 and wherein the mounting openings 124 are separated by the separation element 134;
c) (denoted with reference number 152) depositing the reflector element 136 on at least part of one or both of the lid element 132 and the frame element 130.

The method steps may be performed in the indicated order. It shall be noted, however, that a different order is also possible. The method may comprise further method steps which are not listed. Further, one or more of the method steps may be performed once or repeatedly. Further, two or more of the method steps may be performed simultaneously or in a timely overlapping fashion.

Step c) may further comprise securing the reflector element 136 to an inner surface of one or both of the lid element 132 and the frame element 130. Step c) may comprise one or more of molding, mounting and gluing the reflector element 136 to one or both of the lid element 132 and the frame element 130, specifically to an inner surface of one or both of the lid element 132 and the frame element 130. Further, the lid element 132 and the frame element 130 may be formed integrally, specifically by a molding process. One or more of steps a) and b), may comprise performing a molding process selected from the group consisting of: an injection molding process, a low pressure molding process, a compression molding process, a transfer molding process, a film-assisted molding process, i.e. a film-assisted selective molding process, a thermoforming process, and a rotational molding process. Step b) may further comprise providing the reflector element 136, wherein the reflector element 136 and the lid element 132 are the same element. The method may be configured for manufacturing the spectrometer housing 116 according to any one of the embodiments described above or below in further detail referring to the spectrometer housing 116. The method may further comprise:
d) (denoted with reference number 154) providing the interface element 144 and covering the entrance opening 138 with the interface element 144.

FIG. 5 shows a flow chart of an embodiment of a method of manufacturing the spectrometer module 110. The method comprises:
i) (denoted with reference number 156) performing the method of manufacturing the spectrometer housing 116 according to any one of the embodiments disclosed above or below in further detail referring to a method of manufacturing the spectrometer housing 116;
ii) (denoted with reference number 158) providing the at least one emitter 114 and the at least one detector 112 on the at least one substrate 118, specifically on the circuit carrier 120, more specifically on the printed circuit board 122;
iii) (denoted with reference number 160) arranging the spectrometer housing 116 on the at least one substrate 118, such that the emitter 114 is enclosed within a first of the at least two mounting openings 124, specifically within the emitter compartment 142, of the spectrometer housing 116 and the detector 112 is enclosed within a second of the at least two mounting openings 124, specifically within the detector compartment 140, of the spectrometer housing 116.

The method steps may be performed in the indicated order. It shall be noted, however, that a different order is also possible. The method may comprise further method steps which are not listed. Further, one or more of the method steps may be performed once or repeatedly. Further, two or more of the method steps may be performed simultaneously or in a timely overlapping fashion.

Step iii) may further comprise securing the spectrometer housing 116 to the substrate 118 by performing a bonding process selected from the group consisting of: gluing and soldering. The method may be configured for manufacturing the spectrometer module 110 according to any one of the embodiments described above or below in further detail referring to the spectrometer module 110.

### List of Reference Numbers

110 spectrometer module
112 detector
114 emitter
116 spectrometer housing
118 substrate
120 circuit carrier
122 printed circuit board
124 mounting opening
126 optical filter element
128 light
130 frame element
132 lid element
134 separation element
136 reflector element
138 entrance opening
140 detector compartment
142 emitter compartment
144 interface element
148 method step a)
150 method step b)
152 method step c)
154 method step d)
156 method step i)
158 method step ii)
160 method step iii)

1. A spectrometer housing configured for at least partially enclosing at least one detector and at least one emitter of a spectrometer module, the spectrometer housing comprising:
a frame element;
a lid element connected to the frame element;
a separation element arranged within the frame element;
a reflector element arranged on at least a part of one or both of the lid element and the frame element, wherein the reflector element comprises a metal material selected from the group consisting of: gold, silver, aluminum and any other metal suitable for the generation of metallized surfaces, and
an interface element,
wherein an entrance opening is formed by at least the lid element and the frame element, wherein the frame element and the lid element are fully identical, wherein on a side opposing the entrance opening at least two mounting openings are formed by at least the lid element and the frame element, the at least two mounting openings being separated by the separation element, and wherein the frame element and the separation element are integrally formed from the same material, wherein the interface element is configured for covering the entrance opening.

2. The spectrometer housing according to claim 1, wherein the reflector element is secured to one or both of the lid element and the frame element.

3. The spectrometer housing according to claim 1, wherein a first of the at least two mounting openings is configured for forming part of a detector compartment for receiving the detector and a second of the at least two mounting openings is configured for forming part of an emitter compartment for receiving the emitter.

4. The spectrometer housing according to claim 1, wherein the spectrometer housing is dimensioned to fit within a cuboid having a volume v≤1.5 cm³.

5. A spectrometer module comprising at least one detector, at least one emitter and at least one spectrometer housing according to claim 1.

6. The spectrometer module according to claim 5, wherein the spectrometer module further comprises at least one substrate, wherein the emitter, the detector and the spectrometer housing are arranged on the substrate, wherein the emitter is enclosed within a first of the at least two mounting openings of the spectrometer housing and wherein the detector is enclosed within a second of the at least two mounting openings of the spectrometer housing.

7. The spectrometer module according to claim 5, referring to a spectrometer module, wherein the spectrometer module is dimensioned to fit within a cuboid having a volume v≤1.5 cm³.

8. A method of manufacturing at least one spectrometer housing configured for at least partially enclosing a detector and an emitter of a spectrometer module, the method comprising:
a) integrally forming a frame element and a separation element;
b) providing a lid element, wherein the lid element and the frame element form an entrance opening and at least two mounting openings and wherein the mounting openings are separated by the separation element, wherein the frame element and the lid element are fully identical; and
c) depositing a reflector element on at least part of one or both of the lid element and the frame element, wherein the reflector element comprises a metal material selected from the group consisting of: gold, silver, aluminum and any other metal suitable for the generation of metallized surfaces.

9. The method according to claim 8, wherein step c) further comprises securing the reflector element to an inner surface of one or both of the lid element and the frame element.

10. The method according to claim 8, wherein step c) comprises one or more of molding, mounting and gluing the reflector element to one or both of the lid element and the frame element.

11. The method according to claim 8, wherein the lid element and the frame element are formed integrally.

12. The method according to claim 8, wherein the method further comprises:
d) providing an interface element and covering the entrance opening with the interface element.

13. A method of manufacturing a spectrometer module, the method comprising:
i) performing the method of manufacturing at least one spectrometer housing according to claim 8;
ii) providing at least one emitter and at least one detector on at least one substrate;
iii) arranging the spectrometer housing on the at least one substrate, such that the emitter is enclosed within a first of the at least two mounting openings of the spectrometer housing and the detector is enclosed within a second of the at least two mounting openings of the spectrometer housing.

14. The method according to claim 13, wherein step iii) further comprises securing the spectrometer housing to the substrate by performing a bonding process selected from the group consisting of: gluing and soldering.
